(19) United States
(12) Patent Application Publication
(10) Pub. No.: US 2026/0038998 A1
(43) Pub. Date: Feb. 5, 2026

(54) SECONDARY BATTERY AND MAINTENANCE METHOD OF SECONDARY BATTERY

(71) Applicant: SAMSUNG SDI CO., LTD., Yongin-si, (KR)

(72) Inventor: Eunkang LEE, Yongin-si, (KR)

(21) Appl. No.: 19/013,132

(22) Filed: Jan. 8, 2025

(30) Foreign Application Priority Data
Aug. 5, 2024 (KR) 10-2024-0104037

(51) Int. Cl. H01M 50/645; H01M 50/15; H01M 50/184; H01M 50/186; H01M 50/333

(52) U.S. Cl. CPC H01M 50/645; H01M 50/15; H01M 50/184; H01M 50/186; H01M 50/333

(57) ABSTRACT

A secondary battery includes a can accommodating an electrode assembly, a cap plate joined to an opened upper end of the can, the cap plate including an injection port for an electrolyte to pass therethrough, and a sealing portion joined to an inner surface of the cap plate aligned with the injection port, the sealing portion selectively contacting the injection port through elastic restoring force.

### CROSS-REFERENCE TO RELATED APPLICATION

This application claims priority under 35 U.S.C § 119 to Korean Patent Application No. 10-2024-0104037, filed in the Korean Intellectual Property Office on Aug. 5, 2024, the entire contents of which are hereby incorporated by reference.

### BACKGROUND

### 1. Field

Embodiments relate to a secondary battery and a maintenance method of the secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, the secondary battery including a can accommodating an electrode assembly, a cap plate joined to an opened upper end of the can, the cap plate including an injection port for an electrolyte to pass therethrough, and a sealing portion joined to an inner surface of the cap plate aligned with the injection port, the sealing portion selectively contacting the injection port through elastic restoring force.

The sealing portion may include a hinge portion joined to the inner surface of the cap plate, the hinge portion having an elastic restoring force, and a base portion having one side joined to the hinge portion, the base portion rotating in an inward direction of the can with respect to the hinge portion.

An area of the base portion may be larger than an area of the injection port.

The base portion may seal the injection port in surface contact with the inner surface of the cap plate.

If a pipe is inserted through the injection port, the base portion may rotate downward with respect to the hinge portion to open the injection port.

If the pipe is removed from the injection port, the base portion may be rotated and restored to an upper portion with respect to the hinge portion to close the injection port.

The sealing portion may include a pair of spring portions joined to the inner surface of the cap plate, the pair of spring portions having an elastic restoring force, and a base portion having opposite ends joined to the pair of spring portions.

A separation distance between the pair of spring portions may be greater than a diameter of the injection port.

The base portion may seal the injection port in surface contact with the inner surface of the cap plate, the base portion being joined to the pair of spring portions.

If a pipe is inserted through the injection port, the pair of spring portions may expand and move downward to open the injection port.

If the pipe is removed from the injection port, the base portion closes the injection port by restoring to an upper end as the pair of spring portions elastically restore.

The secondary battery may further include a press-fit portion press-fitted to the injection port, and an elastic pin above the press-fit portion, the elastic pin including a cover portion covering an upper surface of the cap plate adjacent to the injection port.

Embodiments include a maintenance method of a secondary battery, the maintenance method including opening a sealing portion joined to an inner surface of a cap plate by inserting a pipe into an injection port for an electrolyte to pass through the cap plate of a secondary battery, removing vaporized electrolyte and gas inside a can of the secondary battery to which the cap plate is joined, replenishing an electrolyte inside the can of the secondary battery through the pipe and removing the pipe from the injection port.

The maintenance method may further include, prior to the opening of the sealing portion, removing an elastic pin press-fitted to the injection port.

The removing of the vaporized electrolyte and the gas may include inserting the pipe into the injection port to remove a vaporized deteriorated electrolyte from the can, and removing gas generated inside the can.

The replenishing of the electrolyte may further include replenishing an external electrolyte in an amount equivalent to an amount of a reduced electrolyte inside the can.

The sealing portion may include a hinge portion joined to the inner surface of the cap plate, the hinge portion having an elastic restoring force, and a base portion having one side joined to the hinge portion, the base portion being rotated in an inward direction of the can with respect to the hinge portion, wherein, in opening the sealing portion, if the pipe is inserted through the injection port, the base portion rotates downward with respect to the hinge portion to open the injection port.

If the pipe is removed from the injection port, the base portion may be rotated and restored to an upper end with respect to the hinge portion to close the injection port.

The sealing portion may include a pair of spring portions joined to the inner surface of the cap plate, the pair of spring portions having an elastic restoring force, and a base portion having opposite ends joined to the pair of spring portions, wherein if the pipe is inserted through the injection port, the base portion is moved downward to open the injection port while the pair of spring portions expand.

If the pipe is removed from the injection port, the base portion may close the injection port by restoring to an upper end while the pair of spring portions elastically restore.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of skill in the art by describing in detail exemplary embodiments with reference to the attached drawings, in which:

FIG. 1 illustrates a perspective view showing an example of a secondary battery according to one or more embodiments of the present disclosure;

FIG. 2 illustrates an exploded perspective view showing an example of the secondary battery according to one or more embodiments of the present disclosure;

FIG. 3 illustrates a cross-sectional view showing an example of a cap plate, to which a sealing portion is joined, according to one or more embodiments of the present disclosure;

FIG. 4 illustrates a cross-sectional view showing a state in which a pipe is inserted into an injection port in the embodiment of FIG. 3;

FIG. 5 illustrates a cross-sectional view showing an example of a cap plate, to which a sealing portion is joined, according to another embodiment of the present disclosure;

FIG. 6 illustrates a cross-sectional view showing a state in which a pipe is inserted into an injection port in the embodiment of FIG. 5;

FIG. 7 illustrates a cross-sectional view showing a state in which an elastic pin is press-fitted to an injection port in the embodiment of FIG. 3;

FIG. 8 illustrates a cross-sectional view showing a state before the elastic pin is press-fitted to the injection port in the embodiment of FIG. 5;

FIG. 9 illustrates a perspective view showing an example of the elastic pin according to one or more embodiments of the present disclosure;

FIG. 10 illustrates an example of a state in which a secondary battery according to one or more embodiments of the present disclosure is mounted on a module case;

FIG. 11 illustrates an example of replenishing an electrolyte in batch to secondary batteries mounted on the module case of FIG. 10; and

FIG. 12 illustrates a flowchart showing a maintenance method of a secondary battery according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing FIGURES, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the FIGURES, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the FIGURES. It will be understood that the spatially relative terms are intended to encompass different orientations of the device in use or operation in addition to the orientation depicted in the FIGURES. For example, if the device in the FIGURES is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

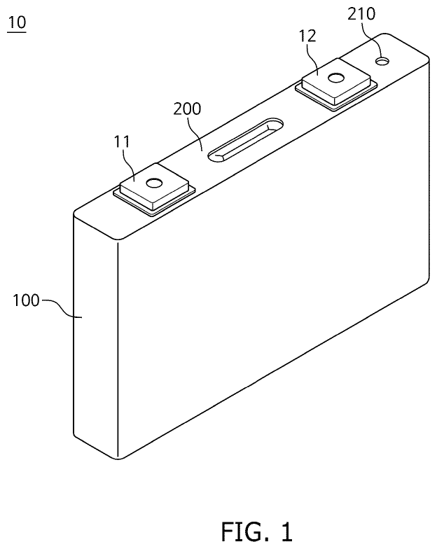

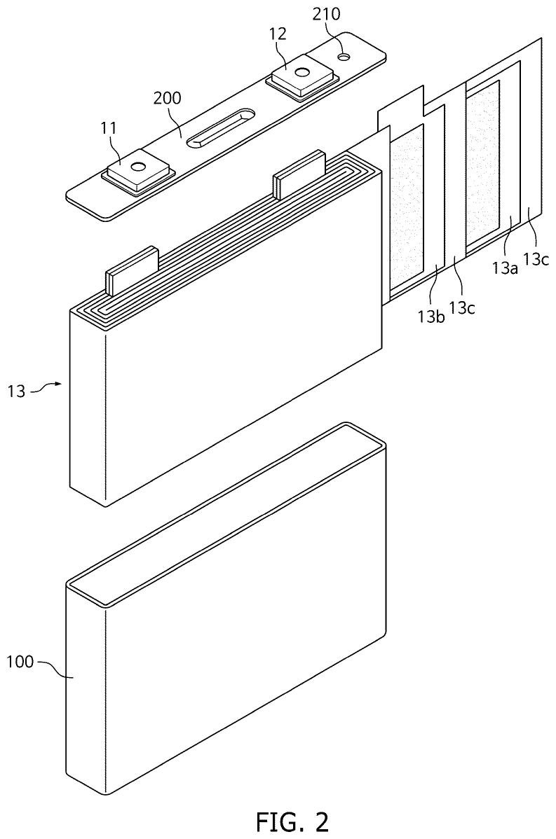

FIG. 1 illustrates a perspective view showing an example of a secondary battery according to one or more embodiments of the present disclosure, and FIG. 2 illustrates an exploded perspective view showing an example of the secondary battery according to one or more embodiments of the present disclosure.

Referring to FIGS. 1 and 2, a secondary battery 10 according to one or more embodiments of the present disclosure may include a can 100 accommodating an electrode assembly 13 therein, and a cap plate 200 joined to the opened upper end of the can 100. An injection port 210 of an electrolyte may be formed to pass through the cap plate 200.

The cap plate 200 may be a conductive metal having a thin plate-shaped body. According to one or more embodiments, the cap plate 200 may include the injection port 210 through which the electrolyte is injected. The injection port 210 may be formed to pass through the cap plate 200 and provided to inject the electrolyte into the can 100 after the cap plate 200 is joined to an opening of the can 100.

The shape of the cap plate 200 is illustrated as a rectangle, but the cap plate 200 may be configured in any shape, such as a circular shape or a polygonal shape, as long as the cap plate may seal the opening of the can in which the electrode assembly is accommodated.

The cap plate 200 may have a terminal plate 11 formed on the upper surface. As illustrated in FIG. 1, two terminal plates may be provided. In this case, one terminal plate 11 may function as a positive electrode and the other terminal plate 12 may function as a negative electrode. In some embodiments, only one terminal plate may be provided.

A rivet terminal may be formed by passing through the cap plate 200, and the rivet terminal may electrically connect the electrode assembly 13 disposed inside the can 100 to the terminal plates 11 and 12 disposed outside the can 100.

The cap plate 200 may be provided with a vent portion for releasing gas inside the can 100 to the outside in a case where the internal pressure of the secondary battery 10 exceeds a threshold range due to a heat event or the like. In a case where the internal pressure of the secondary battery 10 exceeds the threshold range, the vent portion may be ruptured or released to the outside, causing gas, flames, and other materials inside the can 100 to be discharged. Due to this, the internal pressure of the secondary battery 10 may be reduced.

The electrode assembly 13 may include a first electrode 13a, a separator 13c, and a second electrode 13b. The electrode assembly 13 may be formed by winding or stacking a stack of the first electrode 13a, the separator 13c, and the second electrode 13b, which are formed in a thin plate or film shape. For example, the electrode assembly 13 may be a stack type rather than a wound type. In the present disclosure, the shape of the electrode assembly 13 may be, for example, a Z-stack electrode assembly. For example, the electrode assembly 13 may be accommodated in the can 100 by stacking one or more electrode assemblies 13 so that long sides thereof are adjacent to each other. In the present disclosure, the number of electrode assemblies 13 may vary. The first electrode 13a may be a positive electrode and the second electrode 13b may be a negative electrode, or vice versa. For example, the electrode assembly 13 may be in a form in which a plurality of first electrodes 13a, separators 13c, and second electrodes 13b are sequentially stacked.

The can 100 may be formed to have an opening formed at the upper end (in the orientation shown) and a hollow to accommodate the electrode assembly 13 therein. The can 100 may be formed of a conductive metal, such as aluminum, an aluminum alloy, or nickel-plated steel. In some embodiments, the can 100 may be formed of stainless steel (SUS).

FIGS. 1 and 2 illustrate the can 100 having the opening formed at the upper end, but in other embodiments, the can 100 may have openings formed at opposite ends. In that case, the cap plate 200 (two cap plates) may be combined with each opening to seal the can 100.

The cap plate 200 may be joined to the opening of the can 100 after the electrode assembly 13 is accommodated in the can 100, thereby sealing the can 100. The first electrode 13a and the second electrode 13b of the electrode assembly 13 may be electrically connected to the terminal plates 11 and 12 provided in the cap plate 200, respectively.

The electrolyte may be injected and accommodated in the internal space of the can 100. In a case where electronic devices using secondary batteries are operated at high temperature or in a case where the amount of use increases, the positive/negative electrodes and the electrolyte inside the secondary battery may deteriorate. The electrolyte deteriorated inside the can 100 has lower lithium-ion conductivity than the existing electrolyte and is consumed while lowering the viscosity of the electrolyte, causing a degradation in the performance of the secondary battery.

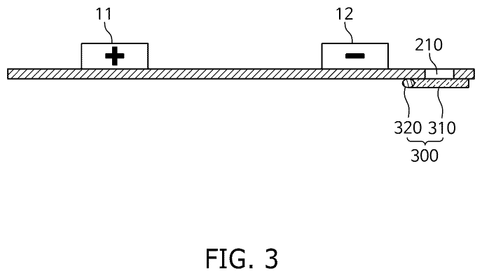

Accordingly, the secondary battery 10 according to one or more embodiments of the present disclosure may be configured so that the deteriorated electrolyte inside the can 100 may be replaced with a new electrolyte even in a case where the assembling is completed. In FIG. 3 and subsequent drawings, the configuration principle that allows removing the deteriorated electrolyte and the gas inside the can 100 and injecting new electrolyte even during use of the secondary battery is described.

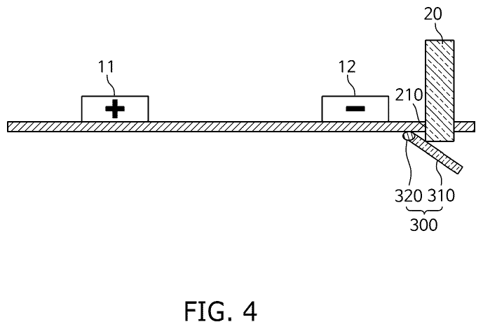

FIG. 3 illustrates a cross-sectional view showing an example of a cap plate, to which a sealing portion is joined, according to one or more embodiments of the present disclosure, and FIG. 4 illustrates a cross-sectional view showing a pipe inserted into an injection port in the embodiment of FIG. 3.

Referring to FIGS. 3 and 4, the secondary battery according to one or more embodiments of the present disclosure may include a sealing portion 300 that is joined to an inner surface of a cap plate 200 corresponding to (e.g., aligned with) a position of an injection port 210, the sealing portion 300 selectively contacting the injection port 210 through elastic restoring force.

The sealing portion 300 may include a hinge portion 320 and a base portion 310. The hinge portion 320 may be joined to the inner surface of the cap plate 200. The hinge portion 320 may be joined to the inner surface of the cap plate 200 to have elastic restoring force.

The base portion 310 may be connected to the hinge portion 320 on one side and may rotate in the inward direction of the can 100 with respect to the hinge portion 320. In one or more embodiments, the base portion 310 may be formed in a plate shape. The area of the base portion 310 may be formed to be larger than the area of the injection port 210. The shape of the base portion 310 may be variously modified as long as the area of the base portion 310 may be formed to be larger than the area of the injection port 210.

The material of the base portion 310 may be the same as the material of the can 100. The base portion 310 may be formed of a conductive metal, such as aluminum, an aluminum alloy, or nickel-plated steel. In some embodiments, the base portion 310 may be formed of stainless use steel (SUS).

The thickness of the base portion 310 may be formed to be equal to the thickness of the cap plate 200. In some embodiments, the thickness of the base portion 310 may be formed to be greater than the thickness of the cap plate 200. The thickness and material of the base portion 310 may be formed by considering the pressure at which the vent portion formed in the cap plate 200 is not opened.

The position where the hinge portion 320 is joined to the inner surface of the cap plate 200 may be set to a position where the base portion 310 may stably seal the injection port 210. The base portion 310 may be in surface contact with the inner surface of the cap plate 200. That is, before the pipe 20 is inserted into the injection port 210, the base portion 310 may maintain a state of being in surface contact with the inner surface of the cap plate 200.

The base portion 310 may maintain a state of being in surface contact with the inner surface of the cap plate 200 due to the elasticity of the hinge portion 320 joined to one side. Due to this, the injection port 210 may be maintained in a sealed state. In a case where the pipe 20 is inserted through the injection port 210, the base portion 310 may be rotated downward with respect to the hinge portion 320 to open the injection port 210. In a case where the pipe 20 is inserted through the injection port 210, the pressing force may be applied to the upper surface of the base portion 310, so that the base portion 310 may be rotated downward (for example, toward the inside of the can) with respect to the hinge portion 320.

In a case where the pipe 20 is removed from the injection port 210, the base portion 310 may be rotated and restored to the upper end with respect to the hinge portion 320 to close the injection port 210. That is, the base portion 310 may be rotated and restored to the upper end with respect to the hinge portion 320 due to the elastic restoring force of the hinge portion 320 joined to one side. In a case where the pipe 20 inserted into the injection port 210 is released, the force pressing against the upper surface of the base portion 310 may be removed and the base portion 310 may be rotated upward with respect to the hinge portion 320.

One end of the pipe 20 may be inserted into the internal space of the can 100 so that the vaporized deteriorated electrolyte inside the can 100 may be removed to the outside. For example, while the pipe 20 supports the base portion 310, the gas existing between the positive electrode, the separator, and the electrolyte inside the can 100 may be removed to the outside.

The pipe 20 may have a cylindrical shape with opposite ends open. For example, in a case where the pipe 20 is inserted through the injection port 210, one end of the pipe 20 may support the base portion 310. In a state in which the pipe 20 supports the base portion 310, the electrolyte may be injected into the can 100 through the opening at one end of the pipe 20.

Accordingly, the cause of increased resistance within the secondary battery and side reactions such as salt precipitation, which lower the performance of the secondary battery, may be eliminated. For example, it is possible to eliminate the cause of performance degradation in secondary batteries, such as electrolyte consumption that may occur due to deteriorated electrolyte inside the secondary battery.

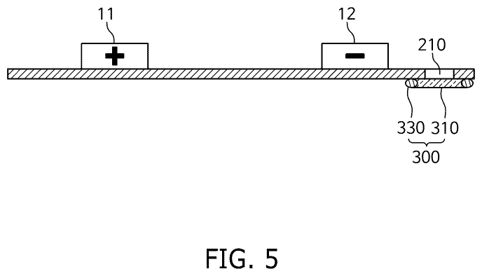

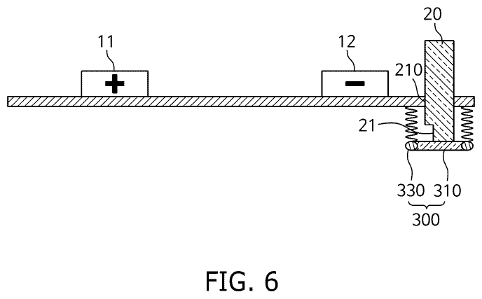

FIG. 5 illustrates a cross-sectional view showing an example of a cap plate, to which a sealing portion is joined, according to another embodiment of the present disclosure, and FIG. 6 illustrates a cross-sectional view showing a state in which a pipe is inserted into an injection port in the embodiment of FIG. 5.

Referring to FIGS. 5 and 6, the secondary battery according to one or more embodiments of the present disclosure may include a sealing portion 300 that is joined to an inner surface of a cap plate 200 corresponding to a position of an injection port 210 and selectively contacts the injection port 210 through elastic restoring force.

The sealing portion 300 may include a spring portion 330 and a base portion 310. The spring portion 330 may be joined to the inner surface of the cap plate 200. For example, the spring portion 330 may be formed as a pair of spring portions. The spring portion 330 may be joined to the inner surface of the cap plate 200 to have elastic restoring force.

In one or more embodiments, opposite ends of the base portion 310 may be joined to the pair of spring portions 330. The base portion 310 may be moved a certain distance in the inward direction of the can 100 via the spring portion 330.

In one or more embodiments, the base portion 310 may be formed in a plate shape. The separation distance between the pair of spring portions 330 may be greater than the diameter of the injection port 210. The shape of the base portion 310 may be variously modified as long as the area of the base portion 310 may be formed to be larger than the area of the injection port 210.

The material of the base portion 310 may be the same as the material of the can 100. The base portion 310 may be formed of a conductive metal, such as aluminum, an aluminum alloy, or nickel-plated steel. In some embodiments, the base portion 310 may be formed of stainless use steel (SUS).

The thickness of the base portion 310 may be formed to be equal to the thickness of the cap plate 200. In some embodiments, the thickness of the base portion 310 may be formed to be greater than the thickness of the cap plate 200. The thickness and material of the base portion 310 may be formed by considering the pressure at which the vent portion formed in the cap plate 200 is not opened.

The position where the spring portion 330 is joined to the inner surface of the cap plate 200 may be set to a position where the base portion 310 may stably seal the injection port 210. The base portion 310 may be in surface contact with the inner surface of the cap plate 200 in a state of being joined to the pair of spring portions 330. That is, before the pipe 20 is inserted into the injection port 210, the base portion 310 may maintain a state of being in surface contact with the inner surface of the cap plate 200.

The pair of spring portions 330 may be joined to the base portion 310 in a compressed state. The base portion 310 may maintain a state of being in surface contact with the inner surface of the cap plate 200 due to the spring portion 330 that is joined to opposite ends and maintained in a compressed state. Due to this, the injection port 210 may be maintained in a sealed state.

In a case where the pipe 20 is inserted through the injection port 210, the base portion 310 may open the injection port 210 by moving downward as the pair of spring portions 330 expand. In a case where the pipe 20 is inserted through the injection port 210, the pressing force may be applied to the upper surface of the base portion 310 and the base portion 310 may be moved downward through the spring portion 330.

In a case where the pipe 20 is removed from the injection port 210, the base portion 310 may close the injection port 210 by restoring to the upper end as the pair of spring portions 330 are elastically restored. That is, the base portion 310 may be restored to the upper end and may be in surface contact with the inner surface of the cap plate 200 due to the elastic restoring force of the spring portion 330 joined to opposite ends. In a case where the pipe 20 inserted into the injection port 210 is released, the force pressing against the upper surface of the base portion 310 may be removed and the base portion 310 may be moved to the upper end.

One end of the pipe 20 may be inserted into the internal space of the can 100 so that the vaporized deteriorated electrolyte inside the can 100 may be removed to the outside. The pipe 20 may have a cylindrical shape with one end open. For example, in a case where the pipe 20 is inserted through the injection port 210, the other end of the pipe 20 may support the base portion 310. While the other end of the pipe 20 supports the base portion 310, the vaporized deteriorated electrolyte inside the can 100 may be removed to the outside through the opening hole 21 adjacent to the other end of the pipe 20.

For example, while the pipe 20 supports the base portion 310, the gas existing between the positive electrode, the separator, and the electrolyte inside the can 100 may be removed to the outside through the opening hole 21.

In some embodiments, while the pipe 20 supports the base portion 310, a new external electrolyte may be injected into the can 100 through the opening hole 21.

Accordingly, the cause of increased resistance within the secondary battery and side reactions such as salt precipitation, which lower the performance of the secondary battery, may be eliminated. For example, it is possible to eliminate the cause of performance degradation in secondary batteries, such as electrolyte consumption that may occur due to deteriorated electrolyte inside the secondary battery.

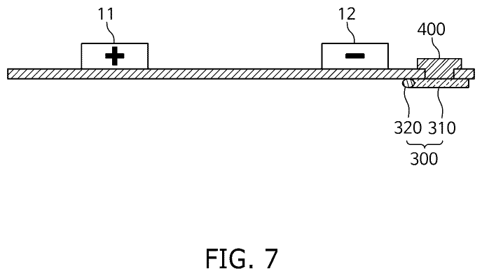

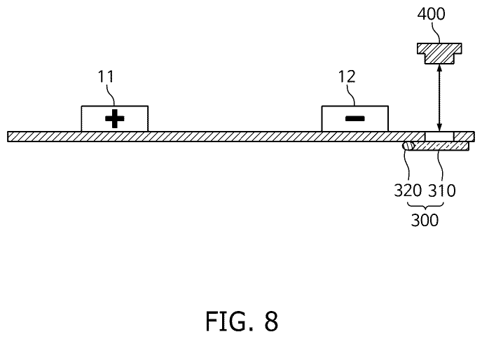

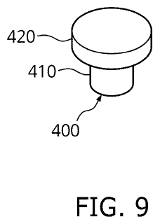

FIG. 7 illustrates a cross-sectional view showing a state in which an elastic pin is press-fitted to an injection port in the embodiment of FIG. 3, FIG. 8 illustrates a cross-sectional view showing a state before the elastic pin is press-fitted to the injection port in the embodiment of FIG. 5, and FIG. 9 illustrates a perspective view showing an example of the elastic pin according to one or more embodiments of the present disclosure.

Referring to FIGS. 7 to 9, an elastic pin 400 according to one or more embodiments of the present disclosure may be inserted into an injection port 210. The elastic pin 400 may be formed of a material capable of elastic deformation. The elastic pin 400 may be inserted into the injection port 210 as a whole.

In one or more embodiments, the elastic pin 400 may include a press-fit portion 410 and a cover portion 420. The press-fit portion 410 may be press-fitted to the injection port 210. For example, the press-fit portion 410 may be formed in a cylindrical shape. In some embodiments, the shape of the press-fit portion 410 may be modified according to the shape of the injection port 210.

The press-fit portion 410 may be press-fitted to the injection port 210 so that the maximum width in the radial direction corresponds to the diameter of the injection port 210. The press-fit portion 410 may be press-fitted and fixed to the injection port 210. The press-fit portion 410 may be configured not to be exposed to the outside while being press-fitted to the injection port 210.

The cover portion 420 may be formed above the press-fit portion 410. The cover portion 420 may cover the upper surface of the cap plate 200 adjacent to the injection port 210. For example, the cover portion 420 may be formed in a disc shape. The size of the cover portion 420 in the radial direction may be larger than that of the press-fit portion 410.

The length of the press-fit portion 410 may be formed to correspond to the thickness of the cap plate 200 in which the injection port 210 is formed. Accordingly, the cover portion 420 may be in contact with the upper surface of the cap plate 200 and cover the upper surface of the cap plate 200 adjacent to the injection port 210. Accordingly, foreign materials may be prevented from entering the injection port 210 after the injection of the electrolyte is completed.

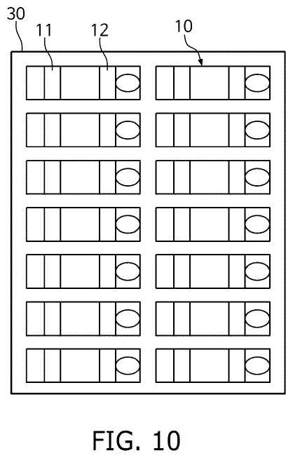

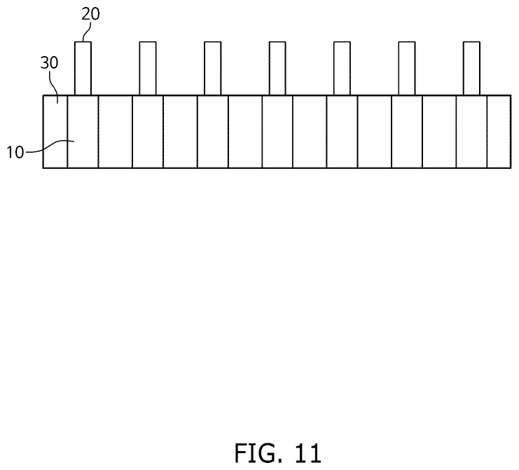

FIG. 10 is a plan view illustrating an example of a state in which a secondary battery 10 according to one or more embodiments of the present disclosure is mounted on a module case 30, and FIG. 11 is a side view illustrating an example of replenishing an electrolyte in batch to secondary batteries mounted in the module case of FIG. 10.

Referring to FIGS. 10 and 11, a plurality of secondary batteries 10 according to one or more embodiments of the present disclosure may be mounted on the module case 30. The assembled module case 30 may be mounted on a vehicle. The plurality of secondary batteries 10 may be mounted on the module case 30 so that the injection port is positioned toward the opened upper side of the module case 30.

After the module case 30 is separated from the vehicle for maintenance, the module case 30 may be placed in equipment having a plurality of pipes 20 installed to inject an electrolyte. The plurality of secondary batteries 10 may be mounted on the module case 30 so as to correspond to the position of the pipe 20.

As illustrated in FIG. 11, the plurality of pipes 20 may be inserted into the injection ports of each of the plurality of secondary batteries, and the deteriorated electrolyte and side reaction gas vaporized into a gaseous state inside the secondary battery may be removed. In some embodiments, the electrolyte may be supplied to the plurality of secondary batteries 10 at once by using the plurality of pipes 20.

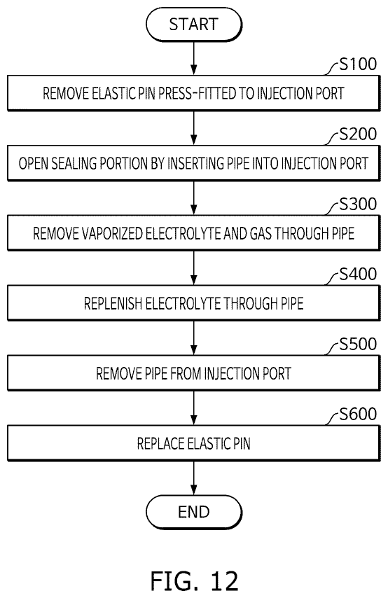

FIG. 12 illustrates a flowchart showing a maintenance method of a secondary battery according to one or more embodiments of the present disclosure.

The maintenance method of the secondary battery according to one or more embodiments of the present disclosure may be started by a step S100 of removing an elastic pin press-fitted to the injection port of the secondary battery. In some embodiments, the maintenance method of the secondary battery may include a step S200 of opening the sealing portion 300 by inserting the pipe 20 into the injection port 210, a step S300 of removing vaporized electrolyte and gas inside the can 100 of the secondary battery through the pipe, a step S400 of replenishing electrolyte inside the can 100 of the secondary battery through the pipe, and a step S500 of removing the pipe 20 inserted into the injection port 210.

In a case where the elastic pin 400 is press-fitted to the injection port 210 so as to prevent foreign materials from entering the periphery of the injection port 210, a step S100 of removing the elastic pin 400 press-fitted to the injection port 210 may be performed prior to a step S200 of opening the sealing portion 300. In the case where the elastic pin 400 is used, it would be replaced after step S500 (S600). In a case where the elastic pin 400 is not press-fitted to the injection port 210, the steps S100 and S600 may be omitted.

In the step S200 of opening the sealing portion 300 by inserting the pipe 20 into the injection port 210, the sealing portion 300 joined to the inner surface of the cap plate 200 may be opened by inserting the pipe 20 into the injection port 210 of the electrolyte which is formed to pass through the cap plate 200 of the secondary battery.

In one or more embodiments, in the step S200 of opening the sealing portion 300, the sealing portion 300 may include the hinge portion 320 joined to the inner surface of the cap plate 200 and having elastic restoring force, and a base portion 310 joined to the hinge portion 320 on one side and rotating in the inward direction of the can 100 with respect to the hinge portion 320. At this time, in a case where the pipe 20 is inserted through the injection port 210 in the step S200 of opening the sealing portion 300, the base portion 310 may be rotated downward with respect to the hinge portion 320 to open the injection port 210.

In another embodiment, in the step S200 of opening the sealing portion 300, the sealing portion 300 may include a pair of spring portions 330 joined to the inner surface of the cap plate 200 and having elastic restoring force, and a base portion 310 having opposite ends joined to the pair of spring portions 330. At this time, in a case where the pipe 20 is inserted through the injection port 210 in the step S200 of opening the sealing portion 300, the base portion 310 may open the injection port 210 by moving downward while the pair of spring portions 330 expand.

After the step S200 of opening the sealing portion 300, the step S300 of removing the vaporized electrolyte and the gas may be performed. The step S300 of removing the vaporized electrolyte and the gas may include removing the vaporized deteriorated electrolyte due to the insertion of the injection port of the pipe 20 inside the can 100 of the secondary battery, and removing the gas generated inside the can 100.

In the step S300 of removing the vaporized electrolyte and the gas, the gas inside the can 100 may be removed to the outside through the pipe 20. In the step of removing the vaporized deteriorated electrolyte, for example, the module case 30 illustrated in FIGS. 10 and 11 may be turned over so that the injection port 210 faces downward, and then the pipe 20 may be inserted through the injection port 210 to remove the vaporized deteriorated electrolyte.

The secondary battery may be kept isolated from the outside before the pipe 20 is inserted, and in a case where the pipe 20 is inserted, the deteriorated electrolyte inside the can 100 may vaporize and exist in a gaseous state. Accordingly, the gaseous electrolyte that has deteriorated due to the use of the secondary battery may be removed to the outside of the can 100 through the pipe 20.

After the step S300 of removing the vaporized electrolyte and the gas is performed, the vaporized deteriorated electrolyte inside the can 100 may be removed, so that the amount of electrolyte becomes less than that of the initial secondary battery. Therefore, in the step S400 of replenishing the electrolyte, the external electrolyte may be replenished in an amount equivalent to the reduced amount of electrolyte inside the can 100.

After the step S300 of removing the vaporized electrolyte and the gas is performed, the step of replenishing the electrolyte S400 may be performed. In the step S400 of replenishing the electrolyte inside the can 100 of the secondary battery, the electrolyte may be replenished inside the can 100 of the secondary battery with the cap plate 200 joined to the upper end through the pipe 20. The step S400 of replenishing the electrolyte may further include replenishing the external electrolyte in an amount equivalent to the reduced amount of electrolyte inside the can 100.

In the step S500 of removing the pipe 20, the pipe 20 inserted into the injection port 210 may be removed. In one or more embodiments, in the step S500 of removing the pipe 20, in a case where the pipe 20 is removed from the injection port 210, the base portion 310 may be rotated and restored to the upper end with respect to the hinge portion 320 to close the injection port 210.

In another embodiment, in a case where the pipe 20 is removed from the injection port 210 in the step S500 of removing the pipe, the base portion 310 may close the injection port 210 by restoring to the upper end while elastically restoring the pair of spring portions 330.

The performance of such secondary batteries is mainly affected by the usage environment, the ambient temperature at which the device is used, the number of uses, and the usage conditions. That is, in a case where the device is operated at high temperature, has high usage, or is used under rapid charge/discharge conditions, deterioration of the positive/negative electrodes and the electrolyte inside the secondary battery occurs.

The deteriorated electrolyte has lower lithium-ion conductivity than the existing electrolyte and is consumed while lowering the viscosity of the electrolyte. Therefore, the deterioration of the electrolyte, the deteriorated electrolyte itself, and the consumption of the electrolyte due to the deterioration of the electrolyte cause a degradation in the performance of the secondary battery. Therefore, the performance such as the lifespan of the secondary battery is mainly affected by how much gas generation and electrolyte deterioration within the secondary battery can be minimized.

In general, secondary batteries have a structure that makes it impossible to perform maintenance to restore performance even in a case where performance deteriorates during use after assembly. That is, the electrolyte injection port is welded and sealed at the assembly completion stage. Thus, in a case where the performance of the secondary battery deteriorates, the secondary battery itself has to be replaced.

The secondary battery described as an embodiment of the present disclosure is a lithium-ion secondary battery, and a prismatic type battery has been described as an example. However, the present disclosure is not limited thereto and may be applied to various types of batteries such as pouch-type batteries or cylindrical batteries.

According to various embodiments of the present disclosure, even in a state where the assembling is completed, the electrolyte that has deteriorated due to use may be replaced with a new external electrolyte, thereby preventing a degradation in the performance of the secondary battery due to electrolyte deterioration.

According to various embodiments of the present disclosure, it is possible to remove gas generated inside the can during use of the secondary battery, thereby preventing an increase in resistance due to the gas generated inside the can and a degradation in performance due to side reactions.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SOME REFERENCE SYMBOLS

100: can
200: cap plate
210: injection port
300: sealing portion
310: base portion
320: hinge portion
330: spring portion
400: elastic pin
410: press-fit portion
420: cover portion

What is claimed is:

1. A secondary battery, comprising:
a can accommodating an electrode assembly;
a cap plate joined to an opened upper end of the can, the cap plate including an injection port for an electrolyte to pass therethrough; and
a sealing portion joined to an inner surface of the cap plate aligned with the injection port, the sealing portion selectively contacting the injection port through elastic restoring force.

2. The secondary battery as claimed in claim 1, wherein the sealing portion comprises:
a hinge portion joined to the inner surface of the cap plate, the hinge portion having an elastic restoring force; and
a base portion having one side joined to the hinge portion, the base portion rotating in an inward direction of the can with respect to the hinge portion.

3. The secondary battery as claimed in claim 2, wherein an area of the base portion is larger than an area of the injection port.

4. The secondary battery as claimed in claim 2, wherein the base portion seals the injection port in surface contact with the inner surface of the cap plate.

5. The secondary battery as claimed in claim 2, wherein, if a pipe is inserted through the injection port, the base portion rotates downward with respect to the hinge portion to open the injection port.

6. The secondary battery as claimed in claim 5, wherein, if the pipe is removed from the injection port, the base portion is rotated and restored to an upper portion with respect to the hinge portion to close the injection port.

7. The secondary battery as claimed in claim 1, wherein the sealing portion comprises:
a pair of spring portions joined to the inner surface of the cap plate, the pair of spring portions having an elastic restoring force; and
a base portion having opposite ends joined to the pair of spring portions.

8. The secondary battery as claimed in claim 7, wherein a separation distance between the pair of spring portions is greater than a diameter of the injection port.

9. The secondary battery as claimed in claim 7, wherein the base portion seals the injection port in surface contact with the inner surface of the cap plate, the base portion being joined to the pair of spring portions.

10. The secondary battery as claimed in claim 7, wherein, if a pipe is inserted through the injection port, the pair of spring portions expand and move downward to open the injection port.

11. The secondary battery as claimed in claim 10, wherein, if the pipe is removed from the injection port, the base portion closes the injection port by restoring to an upper end as the pair of spring portions elastically restore.

12. The secondary battery as claimed in claim 1, further comprising:
a press-fit portion press-fitted to the injection port; and
an elastic pin above the press-fit portion, the elastic pin including a cover portion covering an upper surface of the cap plate adjacent to the injection port.

13. A maintenance method of a secondary battery, the maintenance method comprising:
opening a sealing portion joined to an inner surface of a cap plate by inserting a pipe into an injection port for an electrolyte to pass through the cap plate of a secondary battery;
removing vaporized electrolyte and gas inside a can of the secondary battery to which the cap plate is joined;
replenishing an electrolyte inside the can of the secondary battery through the pipe; and
removing the pipe from the injection port.

14. The maintenance method as claimed in claim 13, further comprising, prior to the opening of the sealing portion, removing an elastic pin press-fitted to the injection port.

15. The maintenance method as claimed in claim 13, wherein the removing of the vaporized electrolyte and the gas comprises:
inserting the pipe into the injection port to remove a vaporized deteriorated electrolyte from the can; and
removing gas generated inside the can.

16. The maintenance method as claimed in claim 15, wherein the replenishing of the electrolyte further comprises replenishing an external electrolyte in an amount equivalent to an amount of a reduced electrolyte inside the can.

17. The maintenance method as claimed in claim 13, wherein the sealing portion comprises:
a hinge portion joined to the inner surface of the cap plate, the hinge portion having an elastic restoring force; and
a base portion having one side joined to the hinge portion, the base portion being rotated in an inward direction of the can with respect to the hinge portion,
wherein, in opening the sealing portion, if the pipe is inserted through the injection port, the base portion rotates downward with respect to the hinge portion to open the injection port.

18. The maintenance method as claimed in claim 17, wherein, if the pipe is removed from the injection port, the base portion is rotated and restored to an upper end with respect to the hinge portion to close the injection port.

19. The maintenance method as claimed in claim 13, wherein the sealing portion comprises:
a pair of spring portions joined to the inner surface of the cap plate, the pair of spring portions having an elastic restoring force; and
a base portion having opposite ends joined to the pair of spring portions,
wherein, if the pipe is inserted through the injection port, the base portion is moved downward to open the injection port while the pair of spring portions expand.

20. The maintenance method as claimed in claim 19, wherein, if the pipe is removed from the injection port, the base portion closes the injection port by restoring to an upper end while the pair of spring portions elastically restore.
